(19) United States
(12) Patent Application Publication
(10) Pub. No.: US 2020/0276980 A1
(43) Pub. Date: Sep. 3, 2020

(54) METHOD FOR CALIBRATING A CHARACTERISTIC DIAGRAM OFA WORK MACHINE AND WORK MACHINE

(71) Applicant: ZF Friedrichshafen AG, Friedrichshafen (DE)

(72) Inventors: Hans HÖFLER, Immenstaad (DE); Udo BREHMER, Friedrichshafen (DE); Thomas KURZ, Langenargen (DE)

(21) Appl. No.: 16/759,373

(22) PCT Filed: Oct. 17, 2018
(86) PCT No.: PCT/EP2018/078331

§ 371 Date: Apr. 27, 2020

(30) Foreign Application Priority Data
Nov. 16, 2017 (DE) 10 2017 220 485.0

(51) Int. Cl. B60W 50/06; F16H 63/40; F16H 61/02; B60W 10/02; B60W 10/18; B60W 10/10; B60W 30/18

(52) U.S. Cl. CPC B60W 50/06; F16H 63/40; F16H 61/0213; B60W 10/024; B60W 10/18; B60W 2050/0088; B60W 30/18109; B60W 2520/30; B60W 2540/12; B60W 2510/02; B60W 10/10

(57) ABSTRACT

A method is described for calibrating a characteristic diagram of a working machine. The characteristic diagram includes a brake pedal characteristic of a brake system and at least one clutch characteristic of a drive input clutch which, in the calibrated condition, have a nominal relationship to one another. The method having the steps of: determining a wheel-side drive output torque; determining an actual brake pedal characteristic with reference to the drive output torque; determining an actual relationship that differs from the nominal relationship by comparing the actual brake pedal characteristic with a nominal brake pedal characteristic; and calibrating the brake pedal characteristic or the clutch characteristic in such manner that the actual relationship corresponds to the nominal relationship. In addition a working machine with a control unit for carrying out the method is described.

This application is a National Stage completion of PCT/EP2018/078331 filed Oct. 17, 2018, which claims priority from German patent application serial no. 10 2017 220 485.0 filed Nov. 16, 2017.

### FIELD OF THE INVENTION

The present invention relates to a method for calibrating a characteristic diagram of a working machine and to a working machine with an electronic control unit for carrying out the method.

### BACKGROUND OF THE INVENTION

From automotive technology, working machines such as forklift trucks, wheel loaders or other special vehicles are known, which are equipped with a hydrodynamic drive unit. The hydrodynamic drive unit usually consists of a drive motor, a hydrodynamic torque converter and a transmission downstream therefrom. In the known working machines it is usual for low travel speeds to be required when picking up certain loads, but in that driving condition the working hydraulic system needs maximum power in order to take up the loads or to carry out other working operations. In order to limit the traction force or torque of the hydrodynamic drive unit at high rotational speeds, the downstream transmission can comprise a friction clutch.

In a driving condition in which high rotational speeds are demanded from the drive motor, the friction clutch is operated in the slipping range in order thereby to make it possible to drive the working machine at a slow speed even when the motor rotational speed is high. For that purpose, in known working machines the control pressure in the friction clutch is reduced in order correspondingly to reduce the clutch torque. The pressure level set at the clutch is determined by the pedal displacement of the brake pedal. In that way, propulsion of the vehicle is controlled by the drive input clutch by way of the pressure level as a function of the pedal position. With this type of control the pressure level set depends on the friction coefficient of the clutch linings and also on the tolerances of the pressure regulators used and of the hydraulic control system. Thus, for the pressure preselected by means of the pedal position, as a function of the tolerances a different torque is obtained at the clutch whereas the pedal position corresponds to a desired torque or clutch torque, the so-termed torque specification, which is transmitted to an electronic control unit and the electronic control unit associates this specification with a corresponding pressure and emits that pressure or the pressure specification to the clutch or the hydraulic valve of the clutch.

From WO 2005/078304 A1 a drive machine is known, which drives both consumers and drive wheels by way of a clutch device. When a brake pedal is actuated an electronic control device determines an input torque of the clutch device and actuates the clutch device in the opening direction when the brake pedal reaches a defined value that depends on the input signal. The value can preferably be obtained from a calculated characteristic which can be readjusted manually.

### SUMMARY OF THE INVENTION

The purpose of the present invention can be achieved by the characteristics specified in the independent claims. Further advantageous design features emerge from the subordinate claims and the drawings.

A method is proposed for calibrating a characteristic diagram for a working machine such as an agricultural or construction machine. The characteristic diagram is preferably stored in an electronic control unit. The characteristic diagram comprises a brake pedal characteristic of a brake system and at least one clutch characteristic of a drive input clutch. Preferably, in the characteristic diagram a braking torque of the brake system as a function of a pedal position of the brake system is stored. In the calibrated condition, the brake pedal characteristic and the clutch characteristic have a nominal relationship to one another. To calibrate the two characteristics, a drive output torque on the wheel side is determined first. With reference to this drive output torque an actual brake pedal characteristic is then determined. By comparing the actual brake pedal characteristic with a nominal brake pedal characteristic, an actual relationship that deviates from the nominal relationship is inferred. The nominal relationship or the relationship of the nominal brake pedal characteristic to the nominal clutch characteristic represents an ideal behavior of the system which, however, changes with the duration of the working machine's service, in particular due to wear. On the basis of the measurement results the actual brake pedal characteristic and/or the clutch characteristic is/are calibrated so that the actual relationship corresponds to the nominal relationship and hence to optimized efficiency. The calibration of the characteristic diagram is preferably carried out automatically by the electronic control unit, in particular so that mass-produced vehicles can be used in an optimum manner throughout their useful life.

The behavior of the drive input clutch of the working machine can be inexpensively optimized by means of this method, so that it can be operated up to the limit of its power without risk of overloading the drive input clutch and thereby damaging it. The characteristic diagram stored in the control unit is essentially tailor-made for the vehicle concerned and can be adjusted as often as desired in order to achieve improved efficiency of the working machine.

Advantageously, a nominal clutch characteristic remains unchanged and/or the actual brake pedal characteristic is calibrated to match the nominal brake pedal characteristic. The nominal clutch characteristic is essentially that set in the factory. Alternatively, the actual brake pedal characteristic remains unchanged and the nominal clutch characteristic is calibrated to match an actual clutch characteristic. The actual clutch characteristic is the clutch characteristic calibrated and adapted to the actual measurement results, by means of which the efficiency of the working machine can be optimized. By calibrating the brake pedal characteristics and/or the clutch pedal characteristics, the system can be operated permanently with low consumption.

It is advantageous if, to determine the drive output torque, from a converter characteristic stored in the electrical control unit, a turbine wheel torque of a hydrodynamic torque converter upstream from the drive input clutch in the power flow direction is determined. By virtue of the turbine torque and the drive output torque, the braking torque, which has a decisive influence with regard to the efficiency of the system, can be determined indirectly.

It is advantageous for the drive output torque to be calculated with reference to the turbine wheel torque, at least one clutch parameter of the drive input clutch and/or with reference to at least one transmission parameter of a transmission downstream from the hydrodynamic torque converter. The parameters required for the calculation can be, for example, a pressure increased by a brake valve as a function of the pedal displacement, friction coefficients, or piston forces for producing the braking force.

It is advantageous if, by way of the drive output torque, a brake characteristic magnitude, in particular a braking torque, also referred to as a brake torque, is determined. With reference to the brake characteristic magnitude, a braking torque of the brake system can be determined indirectly or directly.

Furthermore it is advantageous if, to determine the actual brake pedal characteristic, a value of the brake characteristic magnitude that corresponds to at least one brake pedal position is determined for that brake pedal position. With this additional value the respective brake pedal position can be plotted as a Bezier control point in the characteristic diagram. Thus, the characteristic diagram is always matched individually to the operating and/or wear condition of the working machine at the time, so that it can be operated ideally.

It is also advantageous for the brake pedal characteristic to be determined by a discrete method in which several Bezier control points are determined. The various Bezier control points preferably depict relevant system points. The number of Bezier control points preferably depends on the desired accuracy of the characteristic diagram. The discrete method can be carried out manually by a driver or automatically by the electric control unit, so mass-produced vehicles can be operated with optimized efficiency throughout their useful life.

It is advantageous if, in the discrete method, to determine a Bezier control point the brake pedal position is set to a value and during the determination of the corresponding value of the brake characteristic magnitude it is kept constant at that value. At the beginning of the process the working machine is preferably at rest, and the brake pedal is kept depressed for example by 100%, 75% or 50% of its travel.

With the working machine at rest, advantageously a gear of the transmission is engaged and a motor rotational speed is increased, in particular by means of an accelerator pedal, until rolling of the vehicle is recognized. Rolling is preferably detected by means of a drive output rotational speed indicator associated with one or more tires. Alternatively the rolling can be detected by a movement sensor.

When rolling is detected, the transmission is advantageously automatically shifted to idling mode by the electronic control unit. The value of the brake characteristic magnitude that exists at the moment when rolling begins, in particular the braking torque, is then determined and stored. This forms the first Bezier control point of the actual brake pedal characteristic. With reference to this procedure the characteristic diagram can be updated in a simple manner.

Furthermore, it is advantageous for the actual brake pedal characteristic to be determined in a continuous process, in which the brake pedal position is changed continually and at the same time the corresponding values of the brake characteristic magnitude are determined.

In addition, it is advantageous to accelerate the working machine up to the maximum speed attainable in a gear and then brake it to rest during a deceleration phase by continually increasing the actuation of the brake pedal. The corresponding values of the brake characteristic magnitude are determined during this deceleration phase. The deceleration phase is the test period during which the brake pedal is actuated. In essence, this produces a curve that represents the actual brake pedal characteristic and enables the characteristic diagram to be calibrated.

It is advantageous to carry out the continuous method, in particular in order to determine an initiation point of the actual brake pedal characteristic, first at a first motor rotational speed and then at a motor rotational speed higher than the first motor rotational speed.

Furthermore a working machine is proposed, in particular an agricultural or construction machine. The working machine comprises a drive unit, a hydrodynamic torque converter, a drive input clutch, a transmission, a brake system and an electronic control unit. The brake system is in particular hydraulic. In the control unit is stored a characteristic diagram which comprises a brake pedal characteristic of the brake system and at least one clutch characteristic of the drive input clutch. In the calibrated condition the brake pedal characteristic and the clutch characteristic have a nominal relationship to one another. The electronic control unit is designed in accordance with the foregoing description, wherein the features mentioned can exist individually or in any desired combination.

The working machine is designed to have a long useful life with optimized efficiency by virtue of the characteristic diagram that can be calibrated automatically. If increased wear or higher fuel consumption are noticed, the working machine can be brought to its calibration condition and the characteristic diagram corrected virtually automatically by the control unit.

For this it is advantageous for a converter characteristic of the torque converter to be stored in the electronic control unit. The converter characteristic is preferably a plot of torque of a turbine wheel of a torque converter against the rotational speed ratio between an impeller and the turbine wheel. On the basis of the converter characteristic, the turbine wheel torque and hence the torque at the drive output of the transmission can be determined. From the transmission drive output, conclusions can be drawn about the braking torque, which is relevant for the design of the characteristic diagram of the working machine.

### BRIEF DESCRIPTION OF THE DRAWINGS

Below, the invention is explained in greater detail with reference to drawings, which show:

FIG. 1: A schematic view of a drive-train of a working machine, and

FIG. 2: A characteristic diagram for the working machine in FIG. 1.

### DETAILED DESCRIPTION OF THE PREFERRED EMBODIMENTS

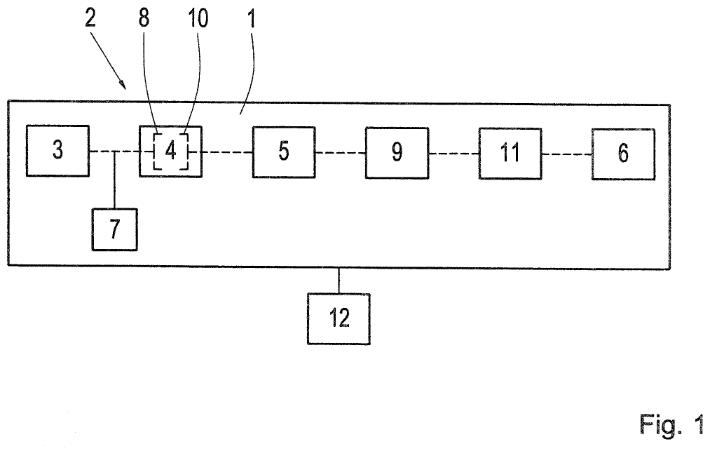

FIG. 1 shows a drive-train 1 of a working machine 2. The drive-train 1 comprises a drive unit 3, which drives one or more consumers by way of a hydrodynamic torque converter 4 and a drive input clutch 5. The working machine 1 drives wheels 6 and at least one power take-off 7 such as hydraulic pumps for actuating loading scoops.

The torque converter 4 is on the one hand functionally connected to the drive unit 3 so that torque of the drive unit 3 can be transmitted to an impeller 8 of the torque converter 4. On the other hand, on the wheel side the torque converter 4 is connected to the drive input clutch 5 and/or to a transmission 9. A turbine wheel 10 of the hydrodynamic torque converter 4 receives the flow energy produced by the impeller 8 and supplies it in the form of mechanical energy to the drive input clutch 5 and the transmission 9, whereby preferably at least one wheel 6 is driven.

On the drive input side, the power take-off 7 is connected upstream from the torque converter 4 and drives for example a high-pressure pump, a concrete mixer or a moving blade. The torque supplied to the power take-off 7 is preferably a function of the torque of the drive unit 3 transmitted to the impeller 8 of the torque converter 4.

Connected upstream from the wheels 6 is a hydraulic brake system 11 such that the wheels 6, for example during driving, can be braked in accordance with the position of a brake pedal (not shown) or prevented from rotating when the vehicle is at rest. To brake the wheels 6, the brake system 11 produces a braking pressure by means of which the braking process takes place.

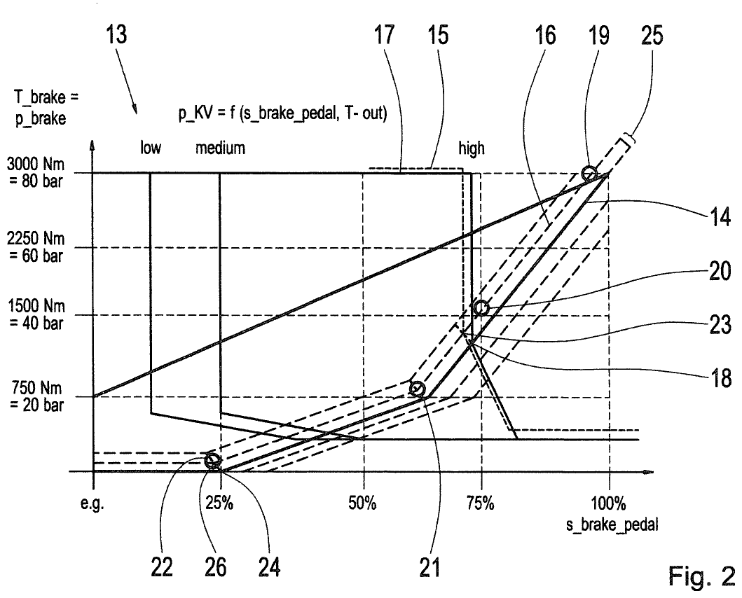

In addition the working machine 2 comprises an electronic control unit 12 by means of which a calibration process can be carried out. In the control unit 12 at least one characteristic diagram 13 (see FIG. 2) of the working machine 2 is stored, which enables the braking torque of the brake system 11 to be determined.

FIG. 2 shows the characteristic diagram 13 for the working machine 2, wherein by comparison with FIG. 1 the same indexes are used for features whose design and/or mode of operation is identical or at least comparable. Insofar as these are not again explained in detail, their design and/or mode of operation corresponds to the design and mode of operation of the features already described earlier.

The x-axis of the characteristic diagram 13 represents a pedal displacement of the brake system 11 and the y-axis represents the braking torque of the brake system 11 (see FIG. 1). The characteristic diagram 13 comprises a nominal brake pedal characteristic 14 of the hydraulic brake system 11 and at least a first actual clutch characteristic 17 of the drive input clutch (see FIG. 1). In the calibrated condition the nominal brake pedal characteristic 14 and the actual clutch characteristic 17 have a nominal relationship with one another. In the calibrated condition an actual brake pedal characteristic 16 and/or an actual clutch characteristic 17 are compared with the respective nominal brake pedal characteristic 14 and/or the nominal clutch characteristic 15. The nominal relationship depicts at least one point of intersection 18 between the nominal brake pedal characteristic 14 and the actual clutch characteristic 17. The position of the point of intersection 18 represents the pedal position at which the drive input clutch 5 is released. The calibrated characteristic diagram 13 makes it possible to determine the braking torque of the brake system 11 independently of the major tolerances thereof.

The nominal brake pedal characteristic 14 has an initiation point 24, which indicates from which pedal position of the brake system 11 the latter engages and thus brakes the working machine 2 or keeps it at rest (see FIG. 1).

To get to the calibrated condition, a wheel-side drive output torque is determined. In the control unit 12, a converter characteristic (not shown) of the hydrodynamic torque converter 4 is stored, which represents the relationship of the rotational speed ratio between the impeller 8 and the turbine wheel 10 on the one hand, and the torque of the turbine wheel 10 on the other hand (see FIG. 1). The drive output torque is calculated with reference to the turbine torque and/or at least one clutch and/or transmission parameter of the drive input clutch 5 or the transmission 9. The clutch and/or transmission parameters are for example the transmission ratio, the pressure at a brake valve which increases in line with pedal displacement, friction values, and/or piston values for producing the braking force.

The drive output torque determined enables the determination of a brake characteristic magnitude, in particular the brake pressure, by means of which a braking torque of the brake system 11 can be characterized.

With reference to the drive output torque an actual brake pedal characteristic 16 can be determined, and for that purpose the brake characteristic magnitude is determined for at least one brake pedal position and a value that corresponds to that brake pedal position. This can be done with the help of a discrete and/or a continuous method.

In the discrete method, the actual brake pedal characteristic 16 is determined by determining several Bezier control points 19, 20, 21, 22 and plotting those points in the characteristic diagram 13.

At the beginning of this method the working machine according to FIG. 1 is preferably at rest. By the control unit 12, which is configured for calibration, or by a driver (not shown), the calibration process is started in that the brake system 11, specifically its brake pedal, is actuated to a first Bezier control point 19. To reach the first Bezier control point 19 the brake system 11 is actuated in such manner that the brake pedal is fully depressed as far as the maximum pedal displacement. At least during the next step the brake pedal remains constantly held at the maximum pedal displacement.

With the working machine 2 at rest a gear is now engaged in the transmission 9. Preferably, the gear engaged is that gear in which the maximum sustainable traction force is produced by the brake system 11. For this, the drive unit 3 is accelerated in the form of a motor rotational speed increase until rolling of the working machine 2 is detected. For that purpose a drive output rotational speed indicator (not shown) or a sensor is preferably installed, in order to be able to detect rotation of at least one wheel 6. The drive input of the drive unit 3 can for example be produced manually by way of an accelerator pedal or brought about automatically by the control unit 12.

When rolling of at least one wheel 6 is detected, the transmission 9 is automatically shifted to idling mode by the electronic control unit 12. At the point when the rolling of the wheel 6 is detected, the associated drive output torque is stored in the control unit 12. The drive output torque is determined by way of the turbine wheel torque stored in the converter characteristic, which in turn in determined by the pump and turbine rotational speed of the impeller 8 and the turbine wheel 10 of the torque converter. Then, from the established drive output torque a braking torque is determined, with reference to which a braking torque of the brake system 11 (see FIG. 1) can be determined. The value existing at the moment of rolling, that corresponds to the braking characteristic magnitude, specifically the brake pressure, is determined and plotted as a braking torque into the characteristic diagram 13 along the y-axis.

Thus, in the characteristic diagram 13 the braking force or braking torque is determined by way of the pedal displacement at a first Bezier control point 19. Preferably the steps, from setting a particular pedal displacement of the brake system 11 while at rest, engaging a gear of the transmission 9 and operating the drive unit 3 at an elevated motor rotational speed until rolling movement of the wheel 6 is first detected, are carried out for different pedal displacements. As shown in FIG. 2, this is carried out a number of times for different pedal displacements of 75%, 60% and 23% to obtain additionally at least a second, third and fourth Bezier control points 20, 21 and 22. The number of Bezier control points 19, 20, 21, 22 can be varied arbitrarily in order to determine as exact an actual brake pedal characteristic 16 as possible.

After determining the actual brake pedal characteristic 16, the actual clutch characteristic 17 is calibrated by forming a nominal clutch characteristic 15 on the basis of the actual brake pedal characteristic 16. Since the nominal relationship is defined by the common point of intersection 18 of the two characteristics 14 and 17, the actual brake pedal characteristic 16 is calibrated on the basis of the nominal brake pedal characteristic 14, in particular in the characteristic diagram 13 displaced in parallel so that the actual clutch characteristic 17, together with the actual brake pedal characteristic 16, form the original point of intersection 18 which essentially represents the nominal relationship.

Displacement of the actual brake pedal characteristic 16 preferably takes place along an offset 25 between the initiation point 24 and a mirror point 26 relative thereto. In the characteristic diagram 13 or FIG. 2, for the sake of simplicity the offset 25 is displaced along the brake pedal characteristics 14, 16. The initiation point 24 of the brake system 11 depends decisively on the wear of the brake system. The greater the wear, as a rule the later the brake system 11 engages or the higher must be the braking torque. Thus, if the actual brake pedal characteristic 16 deviates from the nominal brake pedal characteristic 14, the initiation point 24 also is displaced to the mirror point 26. In the characteristic diagram 13 the mirror point 26 and the initiation point 24 are connected with one another by the offset 25. Preferably, the offset 25 remains the same size throughout the length of the nominal and actual brake pedal characteristics 14, 16. To calibrate the actual brake pedal characteristic 16, it is displaced by the offset 25 relative to the nominal brake pedal characteristic 14, so that the drive input clutch 5 is released at the ideally chosen pedal position corresponding to the intersection point 18 of the actual relationship.

Alternatively, it is conceivable to displace the actual clutch characteristic 17 along the offset 25 relative to a nominal clutch characteristic 15, so that a new calibration point 23 is defined at which the actual relationship corresponds to the nominal relationship at the intersection point 18.

The calibration of the characteristic diagram 13 takes place by the continuous method as previously described, but the actual brake pedal characteristic 16 is determined in this case by continuously varying the brake pedal position instead of moving to individual, discrete Bezier control points 19, 20, 21, 22 as before. At the same time as the continuous variation of the pedal displacement, the corresponding values of the braking characteristic magnitudes, in particular the braking pressure, are determined in order to determine the braking torque. The working machine 2 is accelerated by the drive unit 3 up to the maximum speed attainable in the gear of the transmission 9 engaged at the time. Then, the working machine 2 is slowly braked to rest by continuously increasing the actuation of the brake system 11, in particular its brake pedal (see FIG. 1). During this deceleration phase, in which the working machine 2 is progressively braked, the values of the braking magnitudes that correspond to the pedal displacement are determined so that the braking torque as a function of the pedal displacement can be documented in the characteristic diagram 13. This produces an essentially flowing actual brake pedal characteristic 16, which can be corrected in accordance with the previously described calibration method.

The calibration takes place by correcting either the actual clutch characteristic 17 or the actual brake pedal characteristic 16, in such manner that the actual relationship corresponds to the nominal relationship.

By means of the discrete or the continuous method, the initiation point 24 of the actual brake pedal characteristic 16 can be determined. This enables the calibration of the characteristic diagram 13 to be carried out, so that the opening of the drive input clutch 5 is permanently matched to the braking force or pedal displacement of the brake system 11 and wear or the brake system 11 is prevented. The readjustment of the drive-train 1 can if necessary take place several times during the service life of the working machine 2, so that it is optimally calibrated for any driving situation. The adjustment process takes place at least partially automatically.

The present invention is not limited to the example embodiments illustrated and described. Variations within the scope of the claims are also possible, such as a combination of features, even where these have been illustrated and described in different example embodiments.

### INDEXES

1 Drive-train
2 Working machine
3 Drive unit
4 Torque converter
5 Drive input clutch
6 Wheel
7 Power take-off
8 Impeller
9 Transmission
10 Turbine wheel
11 Brake system
12 Control unit
13 Characteristic diagram
14 Nominal brake peal characteristic
15 Nominal clutch characteristic
16 Actual brake pedal characteristic
17 Actual clutch characteristic
18 Point of intersection
19 First Bezier control point
20 Second Bezier control point
21 Third Bezier control point
22 Fourth Bezier control point
23 Calibration point
24 Initiation point
25 Offset
26 Mirror point

1-15. (canceled)

16. A method of calibrating a characteristic diagram (13) of a working machine (2), the characteristic diagram (13) having a brake pedal characteristic (14; 16) of a brake system (11) and at least one clutch characteristic (15; 17) of a drive input clutch (5) which, in a calibrated condition, have a nominal relationship to one another, the method comprising:
determining a wheel-side drive output torque,
determining an actual brake pedal characteristic (16) with reference to the drive output torque,
determining an actual relationship that deviates from the nominal relationship by comparing the actual brake pedal characteristic (16) determined with a nominal brake pedal characteristic (14), and
calibrating the brake pedal characteristic (14; 16) or the clutch characteristic (15; 17) in such manner that the actual relationship corresponds to the nominal relationship.

17. The method according to claim 16, further comprising either:
maintaining an actual clutch characteristic (17) unchanged and calibrating the actual brake pedal characteristic (16) toward the nominal brake pedal characteristic (14), or
maintaining the actual brake pedal characteristic (16) unchanged and calibrating the actual clutch characteristic (17) toward a nominal clutch characteristic (15).

18. The method according to claim 16, further comprising determining a turbine wheel torque to determine the drive output torque, from a converter characteristic of a hydrodynamic torque converter (4) connected upstream from the drive input clutch (5) in the power flow direction, and the converter characteristic being stored in an electronic control unit (12).

19. The method according to claim 16, further comprising calculating the drive output torque with reference to at least one of the turbine wheel torque, a clutch parameter of the drive input clutch (5), and at least one transmission parameter of a transmission (9) connected downstream from a hydrodynamic torque converter (4).

20. The method according to claim 16, further comprising determining, from the drive output torque, a brake characteristic magnitude with reference to which a braking torque of the brake system (11) is determined either indirectly or directly.

21. The method according to claim 16, further comprising determining a value of the brake characteristic magnitude that corresponds with a brake pedal position to determine the actual brake pedal characteristic (16).

22. The method according to claim 16, further comprising determining the actual brake pedal characteristic by a discrete process in which a number of Bezier control points (19, 20, 21, 22) are determined.

23. The method according to claim 22, further comprising determining one of the Bezier control points (19, 20, 21, 22) by setting the brake pedal position to a value and, during the determination of the corresponding value of the brake characteristic magnitude, keeping the brake pedal position constant at that value.

24. The method according to claim 7, further comprising engaging a gear in the transmission (9) while the working machine (2) is at rest and increasing a motor rotational speed until the working machine (2) starts moving.

25. The method according to claim 22, further comprising, at least one of:
when movement is detected, shifting the transmission (9) automatically to an idling mode via the electronic control unit (12), and
when movement begins, at least one of determining and storing the value of the brake characteristic magnitude existing at the moment.

26. The method according to claim 16, further comprising determining the actual brake pedal characteristic (16) by a continuous process in which the brake pedal position is continuously varied and, at the same time, the corresponding values of the brake characteristic magnitude are determined.

27. The method according to claim 26, further comprising accelerating the working machine (2) up to a maximum speed attainable in a gear and then braking the working machine to rest, during a deceleration phase, by continuously increasing actuation of the brake pedal, and determining the corresponding values of the brake characteristic magnitude during the deceleration phase.

28. The method according to claim 16, further comprising carrying out the continuous process for determining an initiation point of the actual brake pedal characteristic (16), first at a first motor rotational speed and then at a higher second motor rotational speed, by comparing the second motor rotational speed with the first motor rotational speed.

29. A working machine (2) with a drive unit (3), a hydrodynamic torque converter (4), a drive input clutch (5), a transmission (9), a brake system (11), and an electronic control unit (12) in which a characteristic diagram (13) is stored, which diagram includes a brake pedal characteristic (14, 16) of the brake system (11) and at least one clutch characteristic (15, 17) of the drive input clutch (5) which, in a calibrated condition, have a nominal relationship to one another, the electronic control unit (12) is designed to carry out a method of calibrating the characteristic diagram (13) including:
determining a wheel-side drive output torque;
determining an actual brake pedal characteristic (16) with reference to the drive output torque;
determining an actual relationship that deviates from the nominal relationship by comparing the actual brake pedal characteristic (16), determined with a nominal brake pedal characteristic (14); and
calibrating the brake pedal characteristic (14; 16) or the clutch characteristic (15; 17) in such manner that the actual relationship corresponds to the nominal relationship.

30. The working machine according to claim 29, wherein a converter characteristic of the torque converter (4) is stored in the electronic control unit (12).
